(19) United States
(12) Patent Application Publication
(10) Pub. No.: US 2008/0182670 A1
(43) Pub. Date: Jul. 31, 2008

(54) Game and video cartridge for a host device

(76) Inventor: Alan Amron, Brooklyn, NY (US)

Correspondence Address: Alfred W. Froebrich, Esq.;Cohen Pontani Lieberman & Pavane LLP, Suite 1210, 551 Fifth Avenue, New York, NY, 10176, US

(21) Appl. No.: 11/704,847

(22) Filed: Feb. 9, 2007

Related U.S. Application Data
(63) Continuation-in-part of application No. 11/698,699, filed on Jan. 26, 2007.

(51) Int. Cl. A63F 13/00

(52) U.S. Cl. 463/44; 463/43

(57) ABSTRACT

A memory cartridge having an entertainment application is inserted in an interface connected to a host device. The host device is automatically instructed or requested to play the entertainment application residing on the memory cartridge. The instruction may be generated in the host device itself or by the memory cartridge. In response to the instruction, the host device plays the application.

### CROSS REFERENCE TO RELATED APPLICATIONS

The present application is a Continuation-In-Part of U.S. patent application Ser. No. 11/698,699, filed on Jan. 26, 2007, the entire contents of which are expressly incorporated herein by reference.

### BACKGROUND OF THE INVENTION

1. Field of the Invention

The present invention relates to a memory device for electronic devices having an audio, video, or game application that is automatically run by an electronic device upon insertion of the memory device to an interface connected to the electronic device.

2. Description of the Related Art

Electronic devices with visual or audiovisual displays are commercially available in many formats, including such dedicated devices as televisions, projectors, laptop and desktop computers, game devices such as Nintendo Gameboy, Nintendo color Gameboy, Sony Playstation PSP, as well as devices running Windows operating systems and compatible operating systems, such as those from Sony, NEC, Hewlett Packard, and Palm Pilot, Motorola, SamSung, Nikon, Kodak, Sony, and Cannon. The user of such devices must typically navigate through a sequence of menus and configuration screens before the actual game or video application. For example, in a typical game the user must elect whether he or she will be playing in accordance with one set of game rules for a single player stand-alone mode, wherein the only opponent is the computer, or with a different set of game rules in the multiple player networked player game mode, where each of the user's interactions causes responses in accordance with a fixed set of defined rules. In either case, the user's conduct and results are visceral, that is, he wins, he loses, he gains or loses a physical possession such as a sword or power pill, and he uses up some amount of time, energy, points, etc. in the process of playing the game, which ultimately determines how long he is allowed to play the game.

Instead of playing a competitive game, it is desirable in some instances to have an electronic apparatus launch entertainment applications which are not characterized by the notion of winning or losing, more specifically, entertainment applications adapted to entertain without any preliminary configuration or other input on the part of the user.

Some electronic devices have on-board content such as games, video clips and audio. However, the applications are limited to what the specific electronic device manufacturer has loaded on to it. Furthermore, some electronic devices also allow applications to be downloaded. However, this feature uses on-board memory space and is thus limited by the available on-board memory space.

### SUMMARY OF THE INVENTION

An object of the present invention is to provide a memory cartridge storing an entertainment application for a host device having video or audiovisual capabilities, the entertainment application having audio and/or video components that are displayable or playable on the host device in response to insertion of the memory cartridge in an interface of the host device.

The object is met by a memory device connectable to an interface port of a host device having a display and a microprocessor, wherein the memory device stores an entertainment application including primary data having at least one of audio and video components and a file or command that is readable or executable by the host device upon insertion of the memory device into an interface port of the host device or upon turning on the host device when the memory device is inserted into the interface port. The file or command includes or causes generation of a request for the host device to play or display the at least one of audio and video components of the entertainment application. The entertainment application may comprise a movie, cartoon, television program, song, amusement, or game. Specific examples will be described in more detail below.

In one embodiment, the memory device further stores a startup image of the entertainment application. The file or command includes or causes generation of a request to display the startup image before displaying the entertainment application. Alternatively, the data includes a menu image for displaying available menu choices, in which case the file or command includes or causes generation of a request to display said menu image before displaying the entertainment application.

In a further embodiment, the primary data comprises a plurality of versions of the entertainment application, wherein the file or command directs the host device to the appropriate one of the versions. The different versions are applicable to different host devices or different classes of host devices. The file or command includes instructions allowing the host device to determine which of the versions to display.

The memory device may further comprise a video decoder program, wherein the video, which is part of the entertainment application, is decoded by the video decoder program on the memory device to produce decoded information which is transmitted to the host device for display.

The memory device preferably comprises a flash memory or a mini-hard drive. The host devices may comprise televisions, projectors, laptop and desktop computers, game devices such as Nintendo Gameboy, Nintendo color Gameboy, Sony Playstation PSP, as well as devices running Windows operating systems and compatible operating systems, such as those from Sony, NEC, Hewlett Packard, and Palm Pilot, Motorola, SamSung, Nikon, Kodak, Sony, and Cannon.

The object of the present invention is also met by a method for displaying or playing an entertainment application on a host device, comprising the step of inserting a removable memory device into an interface connected to the host device, the memory device storing the entertainment application which includes primary data with at least one of audio and video components of the entertainment application. After the insertion, a request for the host device to automatically display or play the entertainment application is provided, and the host device displays or plays at least one of audio and video components of the entertainment application.

According to one embodiment, the host device checks for a file containing the request stored on the memory device upon insertion of the memory device in the interface and automatically processes the request.

The data associated with the entertainment application may additionally comprise a startup image. In that case, the step of displaying comprises displaying; by the host device, the startup image prior to displaying the entertainment application in response to the request. The step of displaying further comprises displaying or playing the entertainment application in response to the request after said startup image is displayed and in response to a user input to play the at least one or audio and video components of the entertainment application. The user input is provided using manipulable buttons or switches or a touchscreen on the host device.

The data associated with the entertainment application may also comprise a menu image, wherein the step of displaying comprises displaying, by the host device, the menu image prior to displaying the entertainment application in response to the request. The menu image displays at least two items related to different sections of the at least one of audio and video components of the entertainment application in response to the request. The step of displaying further comprises displaying one of said different sections in response to a user input. The user input may be provided using manipulable buttons or switches or a touchscreen on the host device.

The request may provide separate instructions for a plurality of different host devices, each of the separate instructions being specified for an associated one of said different host devices or an associated group of the different host devices. For example, the request may instruct the host device to use instruction set 1 stored at address 1234 if the host device is a SONY camera and use instruction set 2 stored at address 4231 if the host device is a PANASONIC camera. Although only two instruction sets are described in the above embodiment, any number of instruction sets may be included being limited only by the available memory space on the memory cartridge. Furthermore, one or more generic sets of instructions may be included for devices that are not specifically listed.

According to yet another embodiment, the memory device includes a video decoder, wherein the step of displaying comprises decoding a video of the entertainment application using the video decoder on the memory device and sending a stream of decoded data to the host device to be displayed. The video decoder may be selectively used for those host devices that do not have an appropriate video decoder.

The host device may include an autorun application for automatically playing the at least one of audio and video components of the entertainment application stored on the memory cartridge when the memory cartridge is inserted into the interface connected to the host device.

In yet a further embodiment, the memory device itself contains limited processing capabilities. In this embodiment, the memory cartridge runs an application upon being powered up which generates a signal or other instruction which is transmitted to the host device. In response thereto, the host device plays or displays the at least one of audio and video components.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a block diagram depicting the components of a memory cartridge and host device according to an embodiment of the present invention;

FIG. 2 is a block diagram of another embodiment of a memory cartridge according to FIG. 1;

FIG. 3 is a block diagram of another embodiment of a memory cartridge according to FIG. 1;

FIG. 4 is a rear view of a digital camera which may be used as a host device;

FIG. 5 is a rear view of another digital camera with a touchscreen which may be used as a host device;

FIG. 6 is a flow diagram showing the basic steps according to an embodiment of the present invention;

FIG. 7 is a flow diagram according to a further embodiment of the present invention;

FIG. 8 is a flow diagram according to a further embodiment of the present invention;

FIG. 9 is a flow diagram according to yet another embodiment of the present invention;

FIG. 10 is a flow diagram according to still another embodiment of the present invention;

FIG. 11 is a rear view of a digital camera embodiment displaying a video according to the invention;

FIG. 12 is a rear view of a cell phone embodiment displaying an amusement according to the invention; and

FIG. 13 is a schematic diagram illustrating a television connected to an interface for playing an entertainment application on a memory cartridge.

### DETAILED DESCRIPTION OF THE PRESENTLY PREFERRED EMBODIMENTS

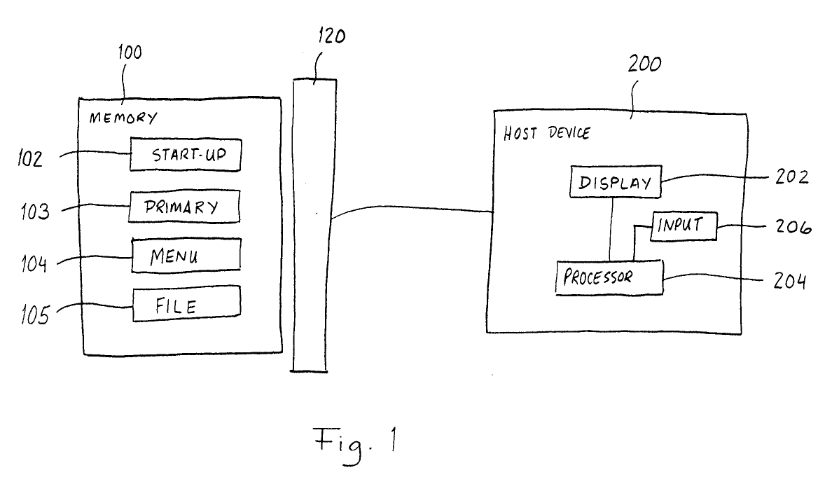

FIG. 1 is a block diagram showing the memory cartridge 100 according to an embodiment of the present invention. The memory cartridge 100 is preferably a portable memory device such as, for example, Mini SD, SD, Compact flash, Sony Stick, or Memory Storage Card, mini hard drive, or any other known or hereafter developed memory storage device. The memory cartridge 100 is removably receivable in an interface 120 which is connected to a host device 200. The interface 120 comprises either an integral part of the host device 200 or a peripheral device that is connected to the host device by, for example, a wired or wireless connection.

The host device 200 comprises any device that is capable of displaying a video or audio visual media and may, for example, include televisions, projectors, laptop and desktop computers, game devices such as Nintendo Gameboy, Nintendo color Gameboy, Sony Playstation PSP, cell phones, digital cameras, personal digital assistants, digital voice recorders as well as devices running Windows operating systems and compatible operating systems, such as those from Sony, NEC, Hewlett Packard, and Palm Pilot, Motorola, SamSung, Nikon, Kodak, Sony, and Cannon. The host device includes at least a display 202, a microprocessor 204, and an input device 206 allowing a user to input commands to the host device 200. The input device 206 typically includes manipulable button and/or switches on the host device 200 or a touchscreen. Alternatively or additionally, the input device 206 may include voice recognition or any other known or hereafter developed input means.

The memory cartridge 100 includes primary data 103 which includes an entertainment application with video and/or audio components. The entertainment application may include a movie, cartoon, television program, song, amusement, or game. According to a simple embodiment of the invention, the host device 200 is programmed to check the memory cartridge 100 for a displayable data upon insertion of the memory cartridge 100 into the interface 120 or upon turning on the host device 200 with the memory cartridge 100 already inserted in the interface 120. In this case, the host device finds the primary data 103 and displays and/or plays video and/or audio components associated with the primary data. Alternatively, the host device may check the memory for an instruction set. For this purpose, the memory cartridge also has a file 105 which includes a request for the host device to display or play the primary data 103. The file includes the information and instructions necessary for the host device to find and play the primary data 103. The file 105 may be configured for a specific host device 200. Alternatively, the file 105 may include separate instructions for a plurality of different host devices. Each separate set of instructions may be directed to one of the host devices or a group of the host devices, i.e., all Sony digital cameras. The file 105 may be an executable file that is run by the host device.

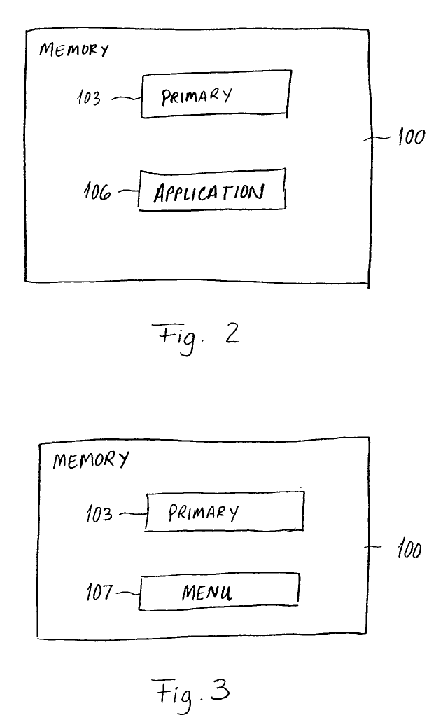

In yet a further embodiment, the memory cartridge includes a program or application 106 (see FIG. 2) that is executed by the memory cartridge for generating a signal or other instruction and transmitting the signal or instruction to the microprocessor 204 of the host device 200, the signal or instruction including a request for the host device to display or play the primary data 103. In this embodiment, the memory cartridge 100 includes some processing capabilities for executing the application or program 106 when the memory cartridge 100 is first powered up, i.e., first connected to a power supply, which is usually via pins in the interface 120. The program or application 106 may also include separate instructions for a plurality of different host devices as described above.

The memory cartridge may also include a separate data section called startup data 102 which includes an initial image to be displayed before the video and/or audio components associated with the primary data of the entertainment application is displayed or played. In this case, the initial image is displayed indefinitely upon initiation of the memory cartridge. The entertainment application is played only upon receiving an input signal from the user indicating that the entertainment application is to be displayed. This can be accomplished using the input device 206.

Alternatively or additionally, the memory cartridge 100 includes a separate data section called menu data 104. In this embodiment, the menu data 104 includes a menu image which is displayed before the video and/or audio components associated with the primary data of the entertainment application is displayed. In a specific embodiment, the entertainment application includes different sections, i.e., separate episodes of a show, separate cartoons or other short programs, or separate starting points in the overall program. When the menu image is displayed, the input device of the host device may be used to select one of the menu items. When selected, the section of the entertainment application associated with the selected menu item is displayed.

In yet another embodiment, the memory cartridge includes function set data 107 (FIG. 3) which defines functions associated with various input means associated with the host device. The function set data 107 may be provided to the host device 200 as part of the file 105 in the embodiment of FIG. 1 or as part of the application 106 in the embodiment of FIG. 2. For example, a digital camera 300 shown in FIG. 4 has a display 302 and has an input buttons 321, 322, 323, 324, and 325. Each of these buttons may be assigned a different function. For example, button 325 may be associated with “play”, button 322 may be associated with “pause”, button 323 with “rewind”, button 321 with “fast forward”, and button 324 may be associated with an “escape” function which switches the device from displaying the application on the cartridge to a normal function of the device. The “escape” function is applicable to a cell phone, wherein a cell phone user may want to stop or pause playback of the entertainment application if a phone call is received. After completing the call, the user may restart the application from the place it was stopped or paused. Alternatively, the host device may automatically resume playback.

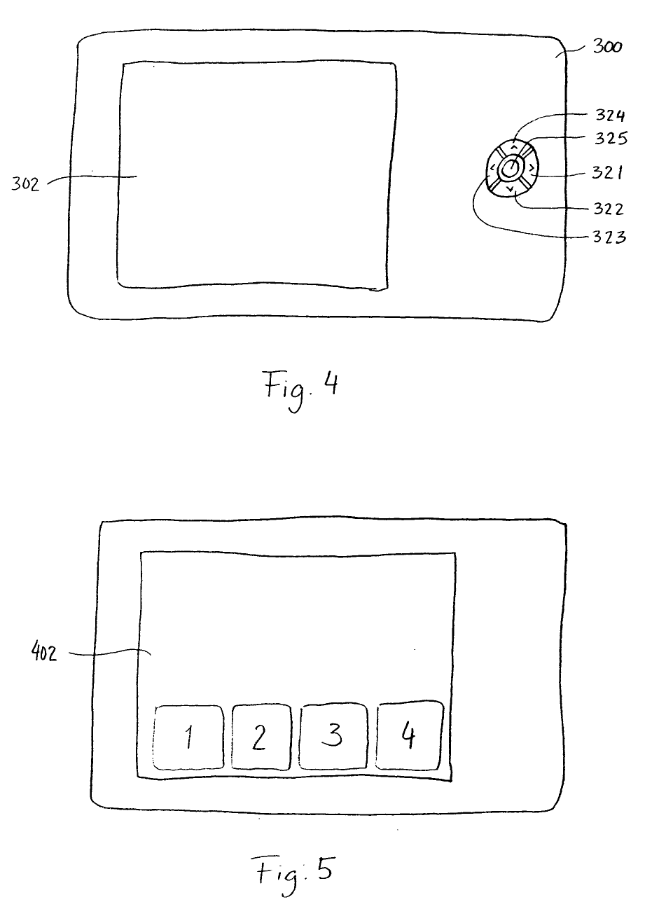

Different devices such as, for example, cell phones have different input devices which may be assigned various functions dependent on the requirements of the entertainment application. Other functions associated with audio and/or video reproductions which are known or hereafter developed may also be assigned to various buttons and/or switches on the host device. Instead of buttons and switches, the functions may be associated with various areas on a touchscreen input device. FIG. 5 is an example of a touchscreen 402 on a host device 400 which shows various areas 1, 2, 3, 4 associated with functions on the touchscreen. Each area on the touchscreen may be associated with a different function for the entertainment application associated with the memory cartridge. Furthermore, some electronic devices which include controllers for playing back video may have the basic playback functions permanently assigned to specific input devices. In that case, the assignment of a function set to an input device is not necessary. The host device simply uses the existing controls to control playback of the entertainment application on the memory cartridge.

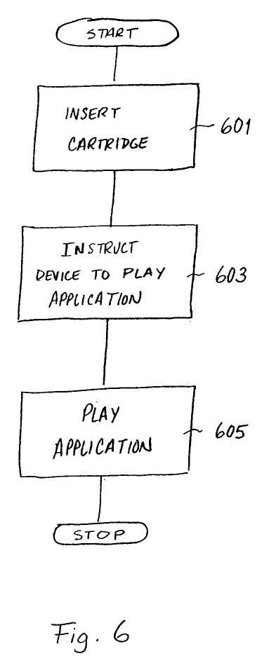

FIG. 6 illustrates a flow diagram of the basic steps according to the present invention. In step 601, a memory cartridge 100 is inserted in an interface 120 connected to the host device 200. The host device is instructed or requested to play the entertainment application on the memory cartridge in step 603. As described below, the instruction may be generated in the host device itself or by the memory cartridge. In response to the instruction, the host device plays the application, step 605.

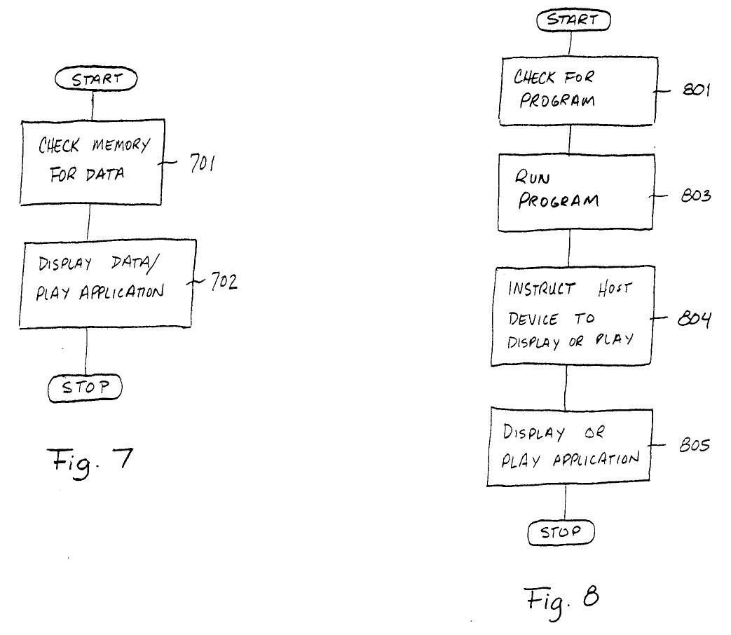

FIG. 7 illustrates a simple embodiment in which the host device 200 automatically checks the memory cartridge 100 for displayable data, i.e., primary data 103, step 701. This step may be preprogrammed in the firmware resident on the host device 200. Alternatively, the original firmware of the device could be updated to perform this specific function as part of an upgrade to the host device for providing the function associated with playing the inventive memory cartridge. Once the displayable data is determined, the host device downloads the data from the memory device and plays the entertainment application, step 703.

FIG. 8 illustrates a further embodiment in which the host device 200 checks for an executable program or file 105, 106 on the memory cartridge 100, step 801. In this embodiment, the program or application is run, step 803, and provides or generates instructions to display or play the entertainment application on the memory cartridge. The program or application may be executed automatically by a program in the host device such as an autorun or other program upon insertion of the memory cartridge in the interface. In response to these instructions, the host device plays the entertainment application, step 807.

In effect, the program or application on the memory cartridge takes over control of the camera operating system. One way to accomplish this is to have the host device programmed to recognize the inventive memory cartridge. As stated above, this can be preprogrammed into the firmware resident on the host device. However, if the firmware is not programmed to recognize the inventive memory cartridge, the memory cartridge can be coded to make the host device believe that the program or application on the memory cartridge is a firmware upgrade. Devices in which firmware is upgradeable typically check an inserted memory cartridge to determine whether it contains a firmware upgrade. This may be indicated by a specific file at a specific location or some other signal know or hereafter developed. If the memory cartridge is found to contain such signal, file, or indication, the host device does not enter the normal operating routine and follows the instructions on the memory cartridge for upgrading the firmware. Accordingly, the memory cartridge of the present invention may include such an indication of a firmware upgrade to take control of the camera and have the camera or other host device follow the instructions in the program or application to play or display the audio and/or video components of the entertainment application.

FIG. 9 illustrates yet another embodiment in which the memory cartridge has processing capabilities. A program or application stored on the memory cartridge is executed by the memory cartridge itself, step 901. The program or application causes the memory cartridge to output a signal instructing the host device to play the entertainment application, step 903. In response to the instructions, the host device plays the entertainment application, step 905.

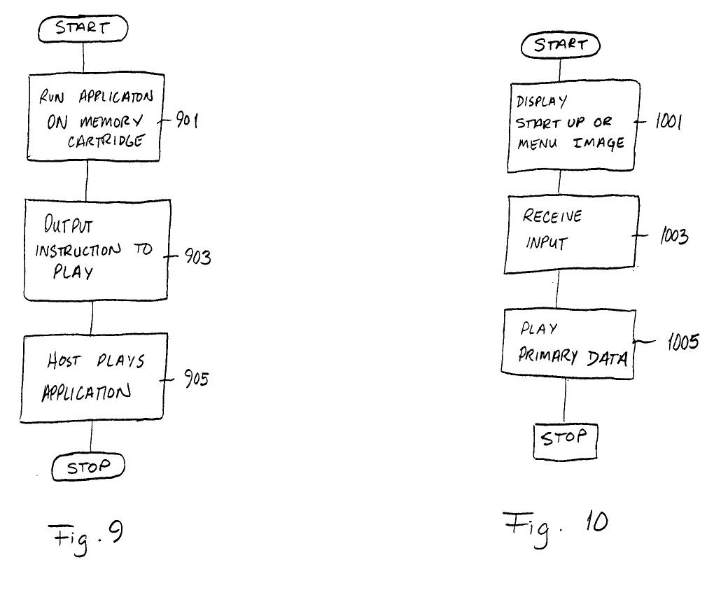

As stated above, the memory cartridge may include menu data or startup image data in addition to the primary data. In each of the steps 605, 703, 807, and 905, the host device first displays the initial data or menu data, step 1001 in FIG. 10, and waits for input. Upon receiving an input, step 1003, the host device determines how to play the primary data, step 1005. As described above, this may include starting at a specific section of the primary data or performing a certain task, i.e., play, fast forward, rewind, etc. As further stated above, functions can be associated with specific keys through the application 106 or the file 105 stored on the memory cartridge.

In each of the steps 805 and 903, the instructions may include a plurality of different versions for different devices. The instructions may include steps which instruct the host device to determine a model number or other identifier of the host device; and then to use version 1 if the host device is, for example, a SONY camera and use version 2 if the host device is a PANASONIC camera.

The entertainment applications to be displayed or played on the host device may include amusement applications such as ETCH-A-SKETCH, or games such as MONOPOLY. In these cases an initial or startup image is displayed and the subsequent images are based on the user input. For example, the ETCH-A-SKETCH application first displays a startup screen that is a blank screen. The user draws on the display using the input device and as the user “draws”, the image is updated to reflect the “drawing” created by the user. In the MONOPOLY application, a user plays the game using the user input device. In this case, the buttons, switches, or touchscreen areas have specifically defined functions such as moving a player along the board, buying a property, etc. By way of further example, the memory cartridge may store video and audio so that the host device would display video or play audio (e.g. cartoons, feature films and/or music albums) controlled by the input by the user—Volume up, Volume down, Play, Pause, Stop, Forward, Reverse, FF, FR, Esc.—upon insertion of the memory cartridge in the interface.

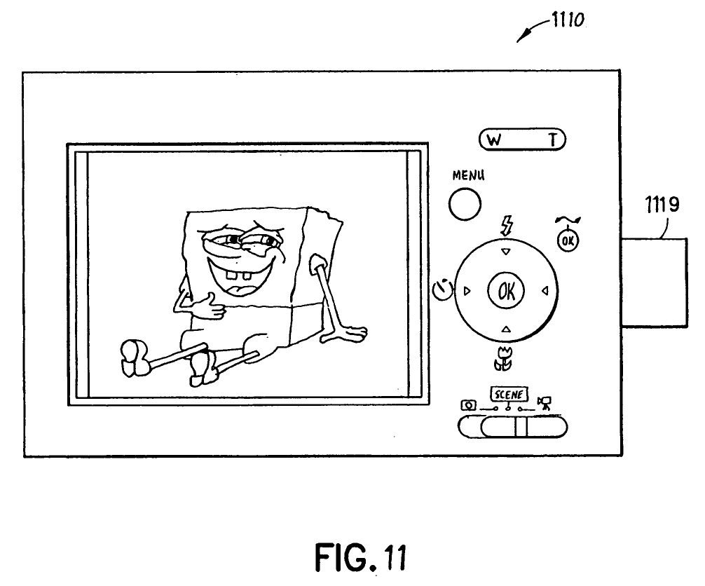

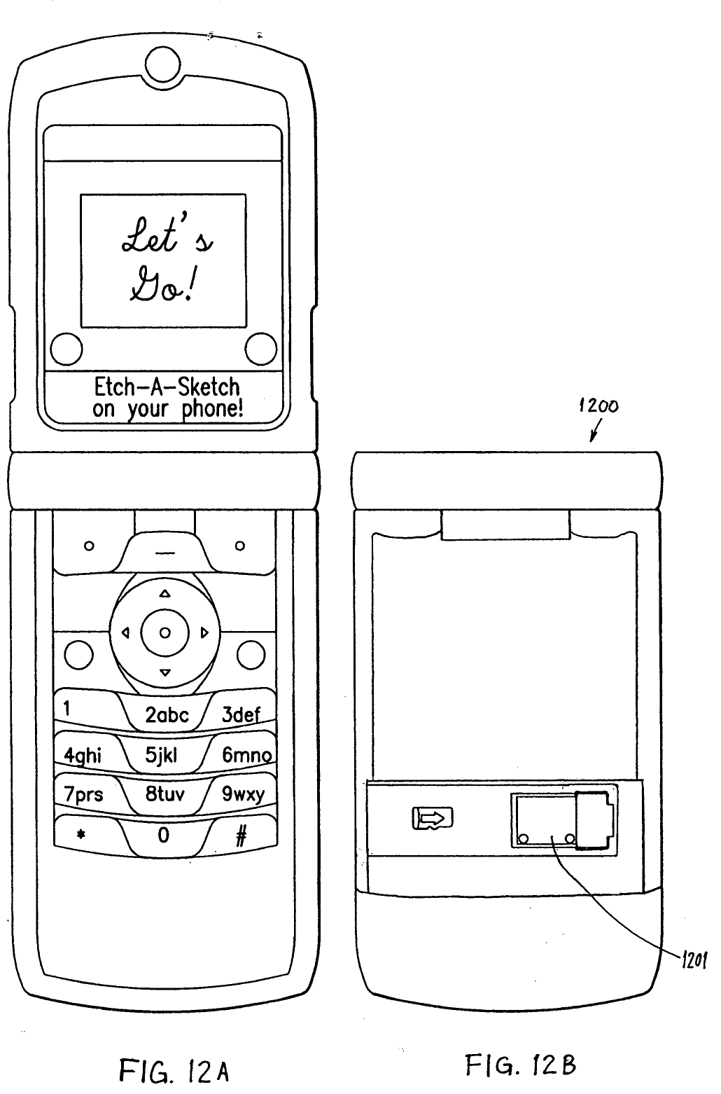

FIG. 11 is an embodiment showing a video from a memory cartridge 1119 being displayed on a display of a digital camera 1110. FIGS. 12A and 12B show a cell phone embodiment in which an ETCH-A-SKETCH amusement image from a memory cartridge 1201 is shown on the display of the cell phone 1200.

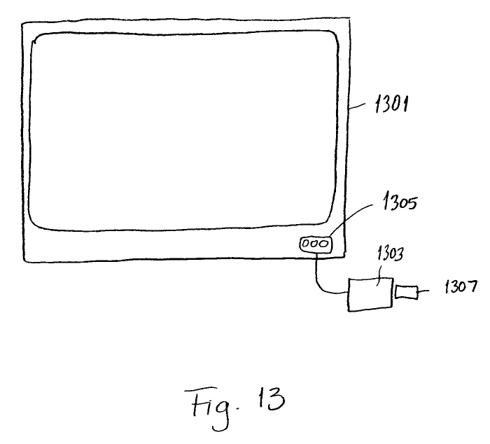

As further shown in the diagram of FIG. 13, the host device may be a television 1301. In this case an interface 1303 may be plugged into or connected to an audio/visual connector 1305 on the television 1301. If the television does not have a video decoder, the video decoder may be contained or stored on the memory cartridge 1307 which is inserted into the interface 1303. The memory cartridge 1307 may comprise any of the embodiments disclosed above. Thus a movie or other video may be viewed without a DVD player or other video player.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A memory device connectable to an interface port of a host device having a display and a microprocessor, said memory device storing:
an entertainment application comprising primary data which includes at least one of audio and video components; and
a file or command readable or executable by the host device upon insertion of the memory device into an interface port of the host device or upon turning on the host device when the memory device is inserted in the interface port, the file or command including a request for the host device to display or play the at least one of video and audio components of said primary data of said entertainment application.

2. The memory device of claim 1, wherein said memory device further stores a startup image and said file or command includes a request to display said startup image before displaying the one of video and audio components of said primary data.

3. The memory device of claim 1, wherein said memory device further stores a menu image for displaying available menu choices and said file or command includes a request to display said menu image before displaying the one of video and audio components of said primary data.

4. The memory device of claim 1, wherein said primary data comprises a plurality of versions of the one of video and audio components, and said file or command includes instructions directing the host device to the appropriate one of said versions.

5. The memory device of claim 4, wherein said file or command includes instructions allowing the host device to determine which of the versions to display.

6. The memory device of claim 1, further storing a video decoder, wherein said one of video and audio components comprises a video application that is decoded by said video decoder program on said memory device to produce decoded information which is transmittable to the host device for display.

7. The memory device of claim 1, wherein said memory device is a portable memory device.

8. The memory device of claim 1, further comprising a file that is executable on said memory device.

9. The memory device of claim 1, wherein said memory device comprises one of mini SD, SD, compact flash, memory stick, memory storage card, or mini hard drive.

10. The memory device of claim 1, wherein the host device is a mobile terminal.

11. The memory device of claim 1, wherein the host device is one of a mobile phone, digital camera, and personal digital assistant.

12. The memory device of claim 1, wherein said host device is a television.

13. A method for displaying or playing an entertainment application on a host device, comprising the steps of:
inserting a removable memory device into an interface connected to the host device, the memory device storing an entertainment application having primary data including at least one of audio or video components;
providing instructions for the host device to display or play the entertainment application; and
displaying or playing, by the host device, the at least one of audio or video components of the primary data in response to the instructions.

14. The method of claim 13, wherein said host device checks for a file stored on the memory device upon insertion of the memory device in the interface, said file containing or generating the instructions, and automatically processes the instructions.

15. The method of claim 13, wherein the memory cartridge further stores a startup image and said step of displaying comprises displaying, by the host device, the startup image prior to displaying or playing the at least one of audio and video components of the primary data in response to the request.

16. The method of claim 15, wherein said step of displaying further comprises displaying the at least one of video and audio components in response to the request after said startup image is displayed and in response to a user input to play or display the entertainment application.

17. The method of claim 16, wherein the user input is provided using manipulable buttons or switches on the host device.

18. The method of claim 16, wherein the user input is provided using a touchscreen on the host device.

19. The method of claim 13, wherein the memory cartridge further stores a menu image and said step of displaying comprises displaying, by the host device, the menu image prior to displaying the at least one of audio and video components of the primary data in response to the request.

20. The method of claim 19, wherein menu image displays at least two items related to different sections of the at least one of audio and video components of the primary data in response to the request, said step of displaying further comprising displaying one of the different sections in response to a user input.

21. The method of claim 20, wherein the user input is provided using manipulable buttons or switches on the host device.

22. The method of claim 20, wherein the user input is provided using a touchscreen on the host device.

23. The method of claim 13, wherein the instructions include separate instruction sets for a plurality of different host devices, each of the separate instruction sets being applicable to an associated one of said different host devices or an associated group of the different host devices.

24. The method of claim 23, wherein the memory cartridge includes a video decoder, wherein the separate instructions include using the video decoder on the memory device for host devices that do not include an appropriate video decoder.

25. The method of claim 13, wherein the memory device includes a video decoder, said step of displaying comprises decoding video components of the entertainment application using the video decoder on the memory device and sending a stream of decoded data to the host device to be displayed.

26. The method of claim 13, wherein said step of providing instructions comprises running a program or file on the memory device which contains or generates the instructions and transmits the instructions to the host device.

27. The method of claim 13, wherein the host device is a camera.

28. The method of claim 13, wherein the host device is a mobile phone.

29. The method of claim 13, wherein said step of playing back the entertainment application comprises pausing the playback in response to a user input to revert to the normal function of the host device.
